(19) United States
(12) Patent Application Publication
(10) Pub. No.: US 2008/0134580 A1
(43) Pub. Date: Jun. 12, 2008

(54) Device and Method For Preparing a Homogeneous Mixture Consisting of Fuel and Oxidants

(75) Inventors: Stefan Kah, Neubrandenburg (DE); Andreas Lindermeir, Goslar (DE); Robert Engel, Torgelow (DE)

Correspondence Address: ROBERTS, MLOTKOWSKI & HOBBES, P. O. BOX 10064, MCLEAN, VA, 22102-8064, US

(73) Assignee: WEBASTO AG, Stockdorf (DE)

(21) Appl. No.: 11/814,040

(22) PCT Filed: Dec. 13, 2005
(86) PCT No.: PCT/DE2005/002254

§ 371 Date: Jan. 10, 2008

(30) Foreign Application Priority Data
Jan. 14, 2005 (DE) 10 2005 001 900.5

(51) Int. Cl. C10L 3/10; B01F 3/02; B01J 19/24

(52) U.S. Cl. 48/197 FM; 422/211; 422/222; 422/190

(57) ABSTRACT

A device for providing a homogenous mixture of fuel and oxidant including an arrangement (5) for feeding liquid fuel to an evaporator, an arrangement (4) for feeding gaseous oxidant into a mixing zone (12) downstream of the evaporator, and a reaction zone downstream of the mixing zone in which a packed structure (3) is arranged. The packed structure can be a ceramic cylindrical molding having a diameter in the range 25 to 35 mm and an axial length in the range 15 to 50 mm or it can have flow conduits that are square in cross-section and have a cell density in the range 400 to 1200 cpsi.

### BACKGROUND OF THE INVENTION

1. Field of the Invention

The invention relates to a device for providing a homogenous mixture of fuel and oxidant including means for feeding liquid fuel to an evaporator, means for feeding gaseous oxidant into a mixing zone downstream of the evaporator, and a reaction zone downstream of the mixing zone. The invention also relates to a method for providing a homogenous mixture of fuel and oxidant including the steps of: feeding liquid fuel to an evaporator, feeding gaseous oxidant and evaporated fuel into a mixing zone downstream of the evaporator, mixing oxidant and fuel in the mixing zone and introducing the mixture having materialized in the mixing zone into a reaction zone.

2. Description of Related Art

Presently, liquid fuels, such as diesel, fuel oil, gasoline, and kerosene represent the most important source of energy for generating heat, mechanical work and electric current, this also being used, e.g., in automotive engine combustion and engine-independent heating and in domestic burners. By contrast, in fuel cell systems liquid hydrocarbons are not totally combusted, but are converted into hydrogen by partial oxidation reactions. Common to both types of reactions is that the liquid fuel first needs to be converted into a gas phase and mixed with air in a mixing chamber before then being converted in the reaction chamber. Strived for in this technology is an optimum homogenous fuel/air mixture since, with increased homogeneity, the proportion of unwanted emissions, in the form of, e.g., soot, NO, and CO, can be reduced. Carbon Monoxide, as a reaction product, is wanted in the scope of a reaction product while it is unwanted as a product of the combustion process.

In modern types of burners and oxidation reactors, the mixing chamber and the reaction chamber are often separated from each other by a molecular seal (mol seal) so that, when using self-igniting fuels, the oxidation reaction does not already commence within the mixing chamber with negative effects.

Evaporating the liquid fuel can be performed by a variety of methods.

From German patent DE 39 146 11 C2, for instance, it is known for the fuel in vehicle heaters to be evaporated on the surface of non-woven metal fiber mats or similarly structured surfaces, for example, woven material, whereby the liquid fuel is applied to a hot non-woven metal fiber mat where it is distributed and then evaporated. After evaporation, the fuel is mixed with air and homogenized in a mixing chamber. In this arrangement, the supply of air for combustion in the combustion chamber occurs in steps through a plurality of air inlet ports in the combustion chamber wall where flames can form, and due to the conduction of heat, radiation and convection, the necessary heat is ultimately provided for evaporation.

Evaporating fuel by means of non-woven metal fiber mats has drawbacks, however. Measurements of the evaporation of diesel fuel indicated very high surface temperatures (as high as 1100° C.) on a non-woven metal fiber mat, i.e., particularly above 400° C., a temperature at which cracking reactions occur to a remarkable degree causing soot production. The drawback here is that the fuel comes into contact with the air only at the surface of the non-woven mat and can thus oxidize. In addition, because of the stepped air supply, most of the combustion air is supplied mainly after evaporation on the non-woven mat. The corresponding low air ratio at the surface of the non-woven mat results in deposits forming on the evaporator which make stable operation difficult and diminishes the useful life. Reaction conditions exist comparable to those in steam cracking, resulting in the system becoming clogged with soot as briefly explained below.

Steam cracking is a method of thermal cracking employed in petrochemistry, in the presence of steam, naptha, a light gasoline fraction, usually being non-catalytically cracked with steam at approx. 800-1400° C. within an externally fired coiled cracking tubing to generate reactive low molecular compounds of ethene and propene. Further, side products formed which are technically interesting include, among other things, aromates (benzol, toluol, xylol). The object in steam cracking is to produce short-chain olefins needed in the chemical industry. As evident from FIG. 4, these are not formed until high temperatures are attained. Forming ethene from ethane is made easier at temperatures exceeding approx. 700° C. and forming ethine from ethene occurs at above 1200° C. This is why it is understandable that, to produce ethene and propene, temperatures of 800 to 900° C. (mean temperature pyrolysis) are employed while forming acetylenes is performed at temperatures exceeding 1300° C. (high temperature pyrolysis). It is likewise evident from FIG. 4 that the hydrocarbons tend to dissociate into the elements C (soot) and H. To reduce the extent of these unwanted knock-on reactions, after the optimum reaction time (0.2 to 0.5 s), the reaction mixture needs to be sufficiently cooled as quickly as possible (0.1 s) so that the rate at which these unwanted products is formed is near zero, resulting in the product composition being kept in check not, by thermodynamic equilibrium, but by slowing down the kinetics.

The cited compounds are, however, highly reactive under the operating conditions that predominant in steam cracking and tend toward condensation and polymerization reactions, resulting in the end in soot being formed and clogging up the reaction coils to the detriment of the corresponding heat throughput, and thus, requiring cracking coils to be regularly replaced. Steam is added to ensure a good radial distribution of heat in the coils by reduction of the partial pressure to promote formation of cracked products by ensuring a conversion of the previously formed, unwanted higher molecular compounds (coke).

Cracking reactions can also be catalyzed heterogeneously, for instance, by surface metal atoms, so-called active centers. The catalytic effect of, e.g., nickel, iron, cobalt in steam reforming methane and other hydrocarbons is described in Applied Catal. A Gen 212 (2001) 17-60 by C. H. Bartholomew.

At such correspondingly high temperatures in the evaporator, pyrolysis reactions take place in the gas phase. Particles and precursors of soot having formed previously on catalytically active surfaces (non-woven mat, evaporator or combustion chamber wall, glow pencil) can speed up this process of homogenous soot clogging.

Soot formation in an evaporator or combustion chamber can negatively influence the evaporator and combustion response, resulting in higher emissions of soot, CO, hydrocarbons, smoke, and aerosols as well as polycyclic aromatics, thus necessitating regular regeneration strategies to get rid of the soot in the evaporator and combustion chamber. The soot is mostly removed by burning it off. requiring the combustion chamber to be correspondingly designed. Because this process at correspondingly high temperatures is kept in check by the transport of the substances involved, the soot and oxidant need to be in contact in the combustion chamber for a long time which may require the combustion chamber volume to be increased accordingly. Furthermore, exceptionally high temperatures can materialize at the surfaces of the combustion chamber, having a negative effect on the material properties and useful life thereof.

Temperatures sensed as high as 1100° C. at the non-woven metal fiber mats and their ambience make for heavy demands on the material stability of the metal fibers and the adjoining components (e.g., glow pencil, mixing chamber).

Unlike fuel evaporation by means of a non-woven metal fiber mat, the cold flame principle as known from European Patent Application EP 1 102 949 B1 and corresponding U.S. Pat. No. 6,793,693 is based on evaporation of the fuel in an air stream preheated to approx. 300° C. The oxidation reactions occuring thereby are equilibrium reactions with oxygen conversion below 20% so that the resulting gas mixture has an outlet temperature of approx. 480° C.

Cold flame evaporators have the disadvantage that the evaporator air needs to be heated by means of a further system component (e.g., electric heater, burner) to temperatures of approx. 300 to 500° C. so that the cold flame reaction (low temperature oxidation) can kick in, to thus avoid spontaneous self-ignition of the fuel/air mixture as occurs at high temperatures. However, in spite of this, preheating of the air is not conducive to fast cold starting and is adverse to dynamic operation.

Although the fuel/air mixtures produced by means of evaporators or nozzles can be safeguarded against spontaneous self-ignition in the evaporator by mol seals between the evaporator and the downstream reaction space (combustion, partial oxidation) this adds to the complexity.

### SUMMARY OF THE INVENTION

The invention is thus based on the object of providing a device and a method for providing a homogenous mixture of fuel and oxidant using non-woven mat evaporation while overcoming the drawbacks of the prior art, at least in part.

The invention is a sophistication of the generic device in that, in the reaction zone, a packed structure is now arranged at the surface of and/or within which oxidation reactions occur which, due to their exothermic response, maintain the packed structure at the operating temperature. Part of the heat liberated is used in the evaporation zone downstream of the evaporator for self-maintenance of the evaporation process; the remainder of the thermal energy is discharged with the product stream. Preferably, partial oxidation of the fuel components (CₓH_{y}) occurs which otherwise could prompt soot formation, for example, aromatics and long-chain hydrocarbons CₓH_{y} with x>4 liquid at room temperature.

Advantageously, the packed structure is configured as a ceramic cylindrical molding having a diameter in the range 25 to 35 mm and an axial length in the range 15 to 50 mm so that the packed structure is sized compatible with the compact configuration of the device in accordance with the invention. For example, the diameter is 30 mm and the axial length is, for example, 20 mm. In addition to using ceramic materials, for example, cordierith, metallic packed structures are also possible. As ceramic materials use can be made, for example, of oxides of silicon, aluminum, alkaline metals (e.g., sodium), alkaline earth metals (e.g., magnesium), heavy metals (e.g., barium), rare earths (e.g., yttrium) respectively mixtures thereof. A preferred ceramic is, for example, cordierith. In addition, non-oxidic ceramics such as, for example, carbides (e.g., silicon carbide) respectively nitrides can also be employed. Packed structures of metallic materials are mostly made from wrappings of metal foils (e.g., FeCr alloy steel); it being just as possible to stack webs or meshes of metal or the like into a packed structure.

Advantageously, the packed structure features flow conduits square in cross section having a cell density in the range 400 to 1200 cpsi, although it is just as possible that, instead of a square cross-section, the flow conduits feature a hexagonal, triangular, round or corrugated cross-section. The conduits may be oriented parallel or at random (similar to a sponge). In addition to the many and varied shapes featured by the packed structure, for example, round, rectangular, racetrack, the possibilities for configuring the cell densities also vary. For instance, cell densities of around 400 cpsi are of advantage while cell densities as high as approx. 1200 cpsi are just as possible at this time.

Usefully, the surface of the packed structure comprises, at least in part, a coating as a catalyst. For example, a rare metal coating may be provided. The surface of the flow conduits of the packed structure can be increased (e.g., Washcoat: layer thicknesses of a few μm) by magnitudes and catalyst activated for implementing catalyst reactions at technically relevant reaction rates. The selectivity as to the wanted partial oxidation products (e.g., CO and H₂) can be enhanced by making use of a suitable catalytically active packed structure for use in catalytic production of hydrogen (partial oxidation, autothermic reforming, steam reforming). Typical washcoat materials are oxides of aluminum, silicon, titanium while typical catalysts includes rare metals, such as, for example, Pt, Pd, Ni, etc.

Furthermore, it can be provided that the reaction zone is followed by a homogenization zone. The products emerging from the packed structure, for instance residual short-chain hydrocarbons, hydrogen, carbon monoxide, water, carbon dioxide can be reconditioned therein much easier into a homogenous mixture than as compared to the fuel/air mixture upstream of the packed structure. This is promoted, among other things, by the resulting diffusion coefficients of the small molecular species (e.g., hydrogen) produced and flame rates being significantly greater than as compared to the long-chain components employed. The significantly higher temperatures of the resulting components further improves the material transport, and thus, the homogeneity. Due to the low hydrocarbon concentration the tendency to soot clogging is low as compared to the mixing chamber.

It also is useful to provide for the homogenization zone to be followed by a further reaction zone. The resulting product mixture can be further oxidized, e.g., by the addition of a further oxidant flow to thus achieve air ratios up into the range of combustion.

The device in accordance with the invention is further rendered more useful in that it is operable in the mixing chamber with a defined air ratio below 0.5, enabling the device to be put to use without spontaneous ignition occurring and thus minimizing the proportion of oxidation reactions and indirectly also the degree of endothermic crack reactions in the mixing chamber. Already ignited mixtures can be engineered to die away.

The device is furthermore improved to advantage by it permitting operation in an evaporation zone between the evaporator and the mixing zone at temperatures not exceeding, or only insignificantly the end boiling point of the fuel used, which for diesel fuel is approx. 360° C. By not exceeding this temperature the proportion of thermic crack products, resulting in sooting up, is corresponding low. Due to the low temperatures there is a minimum tendency of spontaneous self-ignition of the fuel/air mixture. These low temperatures can also result in less soot being formed by the kinetics being limited, than is to be expected by thermodynamic equilibrium calculations.

Furthermore, preferably, the volume of the evaporation zone and the mixing zone is engineered so that the residence times of the fuel oxidant mixture, on average, are of the magnitude of the reaction times of oxidation reactions, this again results in minimizing the tendency of the fuel/air mixture to spontaneous self-ignition. The short residence times can result in less soot being formed because of the reduction in the contact time than is to be expected by thermodynamic equilibrium calculations.

The invention is an improvement over the generic method in that a packed structure is arranged in the reaction zone through which the entire mixture, including the reaction products that have already materialized, are passed. In this way, the advantages and special features of the device in accordance with the invention are also evident in the scope of a method, this applying likewise to the preferred embodiments of the device in accordance with the invention and the preferred method features resulting therefrom.

The invention is based on having discovered that, by providing a packed structure, particularly in conjunction with the further features of the device, the drawbacks of prior art can now be at least partially overcome. Thus, because the air ratio is set defined in the mixing chamber, the evaporator can now be operated so that low temperatures materialize there, so that spontaneous self-ignition is avoided. These low temperatures diminish the sooting tendency of the system, e.g., as prompted by cracking reactions. The mixture forming zone and oxidation zone are now practically separated, thus, doing away with the need for a mol seal. The temperatures in the evaporator are very low and near independent of output, thus correspondingly reducing the thermal stress of the surrounding components. The hydrocarbons can now be selectively partially oxidized in a first reaction stage by means of a catalyst thus minimizing non-selective ways of reaction, particularly cracking and soot forming.

Making use of a non-catalytic first reaction stage has the advantage that the first reaction stage can now be operated at higher temperatures since catalysts can deactivate at excessively high temperatures. Because of the air ratio being defined, engineered control of the formation of the wanted reaction products is now possible. Unlike a naked flame in combustion reactions, all gaseous or liquid hydrocarbon molecules as may be mixed with the gas are now forced to reactingly flow through the packed structure in this selected configuration. In conjunction with the high temperatures., this results in very high conversion rates and compact dimensions respectively. The hydrogen-rich gas mixture having materialized in the first reaction stage can now be homogenized much easier than the hydrocarbon/air mixture with near zero soot being formed, because of the concentration of hydrocarbons (potential crack candidates) being magnitudes smaller. In addition homogenization can now be performed within a significantly expanded operating range (at higher temperatures with longer residence times), after which the hydrogen-rich gas mixture can be supplied to a further reaction zone. Due to the mixture being homogenous the corresponding reaction zone can now be engineered highly compact thereby guaranteeing an homogenous product gas composition. For instance, the hydrogen-rich gas mixture can be further oxidized to be low in emissions. Because the mixture is homogenized, the corresponding combustion chamber/reaction chamber can now be dimensioned highly compactly.

The invention will now be explained in detail by way of particularly preferred example embodiments with reference to the accompanying drawings.

### BRIEF DESCRIPTION OF THE DRAWINGS

FIG. 1 is a diagrammatic representation of a first embodiment of a system for providing a homogenous fuel/air mixture on the basis of liquid fuel;

FIG. 2 is a diagrammatic representation of a second embodiment of a system for providing a homogenous fuel/air mixture on the basis of liquid fuel;

FIG. 3 is a graph plotting temperature and output curves as a function of time as relevant to a device in accordance with the invention; and

FIG. 4 is a graph plotting the free enthalpy of selected hydrocarbons and of the elements carbon and hydrogen as a function of temperature.

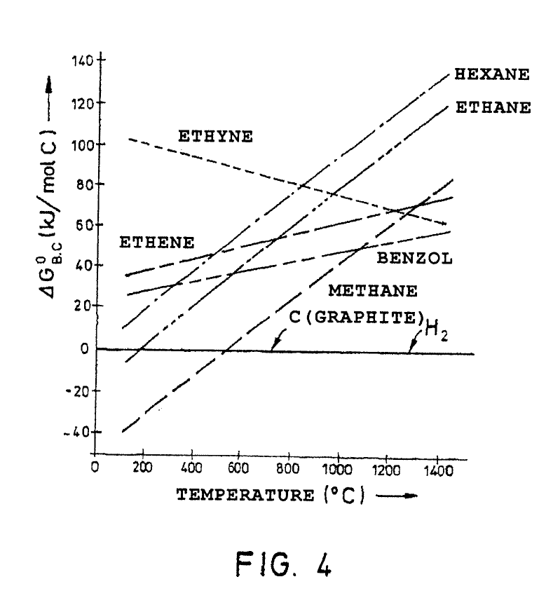

### DETAILED DESCRIPTION OF THE INVENTION

In the following description of preferred embodiments of the invention like reference numerals designate like or comparable components.

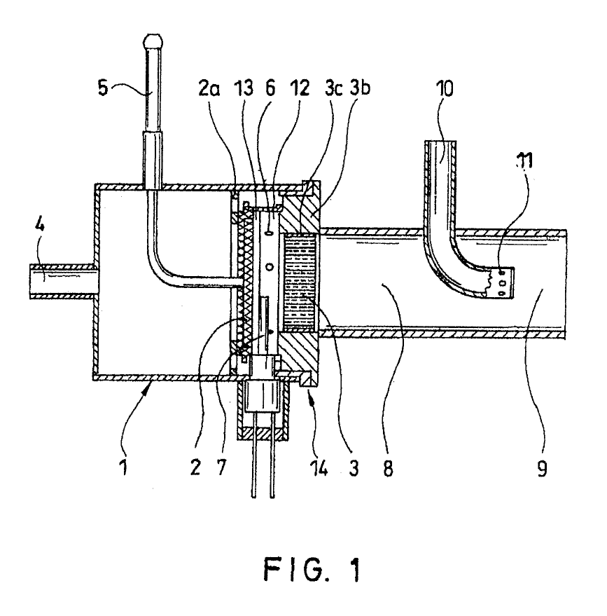

Referring now to FIG. 1, there is illustrated a first embodiment of a system for providing a homogenous fuel/air mixture on the basis of liquid fuel. The core component of the system for providing a homogenous fuel/air mixture on the basis of liquid fuel as shown in FIG. 1, as an example, is the fuel evaporator 2 arranged in an evaporator element 1, attached to which is a supporting element 3b for mounting a packed structure 3 which may be jacketed by a fiber mat 3c for mechanical fixation and thermal insulation respectively.

Liquid fuel and oxidant are supplied to the system via the fuel feeder 5 and oxidant feeder 4 respectively. The oxidant, preferably air, with optional additives, such as, e.g., steam, enters via radially inwardly directed ports 6 into the mixing chamber 12 where the oxidant is mixed with the fuel that has been evaporated in an evaporation chamber 13 that is located upstream of the mixing chamber 12. In general, the evaporation chamber 13 and the mixing chamber 12 form a single unit, evaporation being more likely to occur upstream and mixing downstream, although backflows in the direction of the fuel evaporator may be provided so that here too, fuel and air may be mixed.

Furthermore, as promoted by the low temperatures on the non-woven metal fiber mat, evaporation of high boiling point materials can occur incompletely in the evaporation chamber so that this takes place in the mixing chamber 12 since the fuel flows in the direction of the, for example, 900° C packed structure 3. Oxidation of the fuel/air mixture occurs optionally by an electric igniter 7 or by the packed structure. The homogenization zone 8 adjoining the reaction zone 14 contained in the packed structure 3 serves to homogenize the resulting products of oxidation. The homogenized gas mixture can then be further converted within the further reaction zone 9, e.g., by a supply of oxidant via a further reactant/oxidant feeder 10. The way in which this supply is engineered has a major influence on the material and heat transport in the reaction zone 9. For example, by means of port 11 the reaction products are transported to the wall so that some of the reaction heat can be simply given off to the ambience in thus preventing that the components downstream of the reaction zone 9 become overheated.

Depending on what is required of the application, the system for providing a fuel/air mixture can be operated at a variety of ambient temperatures. With very high ambient temperatures (>400° C.) there is, however, the risk that too much heat enters the fuel evaporator, prompting cracking reactions (e.g., in the non-woven mat). Accordingly, moderate ambient temperatures are of advantage in general. If, however, the application demands on the fuel evaporator require it to be operated in a hot ambience, providing for thermal insulation of the evaporator is of advantage as described below. In this case, it is of advantage when the zones identified 2a and 3b feature a low thermal conductivity, or to engineer the heat conducted to the non-woven mat to be a minimum as can be done, for example, by providing thin ridges in the zone identified 2a. Furthermore, it may be of advantage to provide a thermal insulator (not shown in FIG. 1), for instance a ceramic disk, between the zones 2 and 3b. Also possible is thermal insulation of the evaporator as may be applicable, this applying likewise to the oxidant and fuel paths.

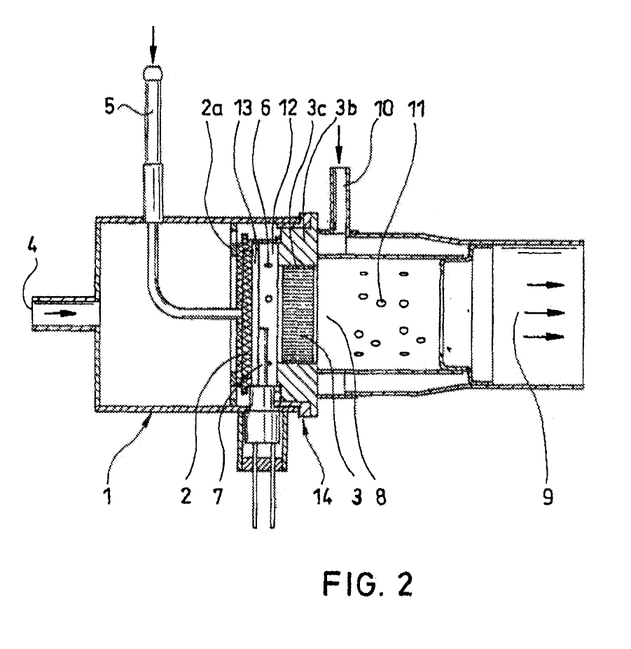

Referring now to to FIG. 2, there is illustrated a diagrammatic representation of a second embodiment of a system for providing a homogenous fuel/air mixture on the basis of liquid fuel. Unlike the embodiment of FIG. 1, the supply of the oxidant flow in the second reaction zone is multiply stepped and oriented radially inwards via a plurality of ports 11.

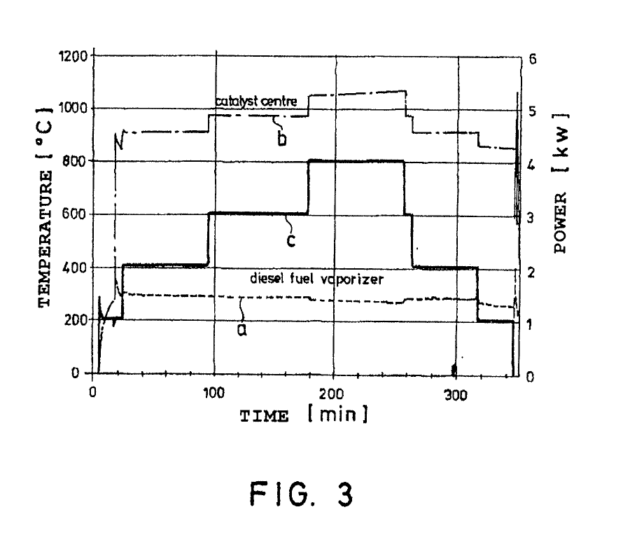

Referring now to FIG. 3, there is illustrated a graph plotting temperature and output curves as a function of time as is relevant to a device in accordance with the invention. Shown are the exemplary results obtained with such a system with diesel evaporation in air. The packed structure 3 employed contains a catalyst which partially oxidizes the diesel fuel so that a hydrogen-rich gas mixture materializes. This can be made use of in, e.g., an auxiliary power unit (APU) for generating electricity and heat. FIG. 3 plots the temperatures as measured in the evaporator chamber (curve a) and in the catalyst (curve b) for the thermal outputs (curve c) between 1 and 4 kW and an air ratio of 0.3 to 0.35. As is evident, the temperature in the evaporation chamber is approx. 300° C. Despite the high temperature at the center of the catalyst (max. 1100° C.) no flashback of the fuel/air mixture occurs within the mixing chamber. Even when the residence time within the mixing chamber is increased (reduction in the thermal output from oxidant feeder 4 to 1 kW) no ignition is observed in thus achieving stable operation.

It is understood that the features of the invention as disclosed in the above description, in the drawings and as claimed may be essential to achieving the invention both by themselves or in any combination.

1-10. (canceled)

11. A device for providing a homogenous mixture of fuel and oxidant including
means for feeding liquid fuel to an evaporator,
means for feeding gaseous oxidant into a mixing zone downstream of the evaporator, and
a reaction zone downstream of the mixing zone,
wherein in a packed structure is arranged in the reaction zone.

12. The device as set forth in claim 11, wherein the packed structure comprises a cylindrical ceramic molding having a diameter in the range 25 to 35 mm and an axial length in the range 15 to 50 mm.

13. The device as set forth in claim 11, wherein the packed structure comprises flow conduits with a square cross-section having a cell density in the range 400 to 1200 cpsi.

14. The device as set forth in claim 11, wherein at least in part a surface of the packed structure has a catalytic coating.

15. The device as set forth in claim 11, wherein the reaction zone is followed by a homogenization zone.

16. The device as set forth in claim 11, wherein the homogenization zone is followed by a second reaction zone.

17. The device as set forth in claim I 1 wherein a defined air ratio below 0.5 is provided in the mixing chamber.

18. The device as set forth in claim 11, wherein the device is adapted to limit temperatures in an evaporation zone located between the evaporator and the mixing zone to temperatures that essentially do not exceed an end boiling point of the fuel.

19. The device as set forth in claim 18, wherein the evaporation zone and the mixing zone have volumes which cause residence times of the fuel oxidant mixture, on average, to be of the magnitude of reaction times of oxidation reactions produced.

20. A method for providing a homogenous mixture of fuel and oxidant including the steps:
feeding liquid fuel to an evaporator,
feeding gaseous oxidant and evaporated fuel into a mixing zone downstream of the evaporator,
forming a mixture by mixing oxidant and fuel in the mixing zone, and
introducing the mixture formed in the mixing zone into a reaction zone in which a a packed structure is arranged and through which the mixture is passed to a homogenization zone.
the homogenization zone is followed by a second reaction zone.

21. The device as set forth in claim 20, wherein a defined air ratio below 0.5 is provided in the mixing zone.

22. The device as set forth in claim 20, wherein the device is operated so as to limit temperatures in an evaporation zone located between the evaporator and the mixing zone to temperatures that essentially do not exceed an end boiling point of the fuel.

23. The device as set forth in claim 22, wherein the fuel oxidant mixture is caused to have average residence times in the mixing zone that are of the magnitude of reaction times of oxidation reactions produced.
